(19) United States
(12) Patent Application Publication
(10) Pub. No.: US 2020/0260769 A1
(43) Pub. Date: Aug. 20, 2020

(54) Method and apparatus for producing tailored compositions of Aloe Vera with probiotics and minerals products

(71) Applicants: Dan Josef Eigeles, Hadera (IL); Madalina Ioana Culcusica, Uzuznu-Giurgiu (RO)

(72) Inventors: Dan Josef Eigeles, Hadera (IL); Madalina Ioana Culcusica, Uzuznu-Giurgiu (RO)

(21) Appl. No.: 16/350,393

(22) Filed: Feb. 15, 2019

(51) Int. Cl. A23L 33/105; A23N 1/02

(52) U.S. Cl. CPC A23L 33/105; A23N 1/02

(57) ABSTRACT

According to the present invention Aloe Vera jell or juice extracted by hygienic methods are used to grow probiotic bacteria in controlled environment. The bacteria are then separated by centrifugal means by bacteria type. Further on tailored optimized mixtures of Aloe Vera jell or juice, dairy products, minerals and probiotics are combined according to specific dietary requirements and/or for topical application products.

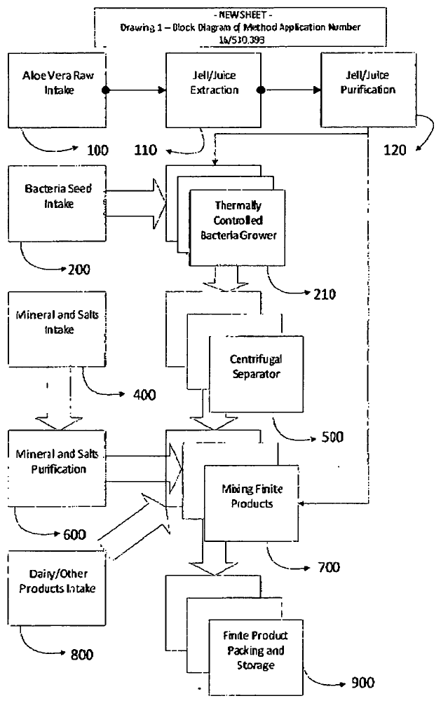

### TECHNICAL FIELD

This application belongs to the field of food supplement and cosmetics development and production.

### BACKGROUND ART

It is well known that products based on Aloe Vera gel provide significant health benefits hence Aloe Vera gel is being extensively used in cosmetic, pharmaceutical and food industries. The Aloe Vera plant contains vitamins, minerals amino acids and antioxidants (https://www.medicalnewstoday.com/articles/318591.php).

Dairy products containing lactobacillus, Bacillus bifidus and other probiotic germs who may have different versions and named here collectively “bacteria” are proven to be beneficial for the intestinal flora (https://www.webmd.com/digestive-disorders/what-are-probiotics #1, https://en.Wikipedia.org.wiki/Lactobacillus_acidophilus).

Different bacilli have different optimal growth temperature. For example Lactobacillus acidophilus optimal growth temperature is 37 Celsius degrees https://en.Wikipedia.org.wiki/Lactobacillus_acidophilus).

There are different types of probiotic agents with offering different types of nutrient benefits selectively related with the support of the digestive system, the immune system, the dermal system, the cardiovascular system and so on (https://www.healthline.com/health/types-of-probiotics//common-probiotics)

The synergy of Aloe Vera juice and prebiotics has been shown (http://www.ghrnet.org/index.php/joghr/article/view/2039/23991) suggesting that an Aloe Vera environment provides an excellent probiotic development partner.

A study published in Journal of Gastroenterology and Hepatology Research” (vol. 3,6, no 3, 2017) showed that temperature ad Aloe Vera juice concentration directly impact the growth of probiotic agents (http://www.gbrnet.org/index-php/joghr/article/view/2039/2399)

A number of granted patents describe different methods of using Aloe Vera polysaccharides for obtaining probiotics (microorganisms) originating from buttermilk—(U.S. Pat. No. 10,117,884 Sinnott; Robert A. Sinnott; Robert A. U.S. Pat. No. 9,855,288).

### SUMMARY OF INVENTION

Aloe Vera juice and gel are perfect beds for rapidly and efficiently growing different types of probiotic agents. Next the term jell shall be used for both Aloe Vera Jell and Aloe Vera Juice. The probiotic agents are then used in combination with Aloe Vera derivatives such as jell and/or juice and/or dairy products and/or mineral slats for obtaining tailored end deliverable goods. This invention deals with the method and apparatus for practically producing the said goods.

### BRIEF DESCRIPTION OF DRAWINGS

Drawing 1 exemplifies the method and the main subsystems of the present invention. The drawing may be also seen as a process flowchart which is consistent with the explicit claims related to this invention.

### DETAILED DESCRIPTION OF DRAWING 1

The Aloe Vera raw material (die cactus leaves) enters the manufacturing process at the Aloe Vera Intake (100) and then it is passed to the Jell/Juice Extraction phase (110) followed by the Jell/Juice Purification (120). Once purified, some part of the extracted jell/juice is directed to the Thermal Controlled Bacteria Grower(s) (210) and the rest of the extracted jell/juice is directed to the Mixing Finite Products (700). Bacteria seed(s) such as such as by way of example may be Lactobacillus, Bifidobacterium, Escherichia, Enterococcus, Bacillus, Propionibacterium or Saccharomyces are taken in at the Bacteria Seed Intake 200 from which each type of bacteria or Intended mixture of multiple bacteria is directed to one of the Thermally Controlled Grower(s) (210). The bacteria needs are grown in the grower on a mowing bad made of the purified Jell/Juice. Once the process of bacteria growing is completed the grown bacteria is separated from the growing bed by one of the Centrifugal Separators (500).

Minerals and salts are taken in and purified at the Mineral and Salt Purification (600).

Diary or other products are taken in at the Diary/Other Products intake (800)

According to the desired formulae bacteria from the Centrifugal separator (500), mineral salt from Mineral Salt Purifier (600) and diary or other product from the Diary/Other Products Intake (800) are streamed to the phase of Mixing Finite Products (700). A finite product shall always contain jell or juice extracted from Aloe Vera hut in addition it may contain any combination of components electively streamed from a Centrifugal Separator (500). Mineral and Salt Purification (600) and/or Diary/Other products intake (800).

Finally, the end product is Packed and stored ready for delivery (900).

### DESCRIPTION OF THE INVENTION

In a first step the Aloe Vera jell is extracted from the Aloe Vera leaves and the probiotic agents are collected from animal sources since originally this is where they Originate from. Then the probiotic bacteria are separated for example by using dedicated centrifugal means so that each of them is isolated from the others.

In the second step each probiotic agent is grown in a dedicated chamber in a pure Aloe Vera juice or jell or diluted with purified water at optimal concentration and temperature which is used as a growing bed.

At this point the nutrient or therapeutic power of the said probiotic agent is maxima). Then the grown bacteria is separated from the growing bed composed of pure Aloe Vera jell or Aloe Vera jell diluted with purified water.

In the third step probiotic controlled mixers are used to produce homogeneous mixes of probiotic agents of the desired type and concentration with dairy products such as cultured buttermilk for per os intake or used to be combined with different cosmetics products making use of Aloe Vera derivatives such as for example Aloe Vera jell for topical application which may also be combined with mineral salts. It is well known that

In the fourth step the final product is packed and ready for distribution.

We claim:

1. A Method end apparatus for producing synergetic tailored per os administered Aloe Vera and dairy products or Aloe Vera and probiotic with or without mineral salt products for topical use wherein:
a. A subsystem for extracting Aloe Vera jell and or juice from the Aloe Vera leafs and;
b. A purifying subsystem for cleansing the extracted Aloe Vera from impurities and;
c. A set of thermally controlled bio chambers in which bacteria are grown on an Aloe Vera stratum and;
d. A set of controlled speed centrifuges for separating different bacteria from one another as well as separating bacteria from the Aloe Vera stratum mentioned in c above and;
e. A minerals purifying and fine milling mineral salts and;
f. An array of subsystems mixing the finite products

2. A subsystem for extracting Aloe Vera jell from the Aloe Vera leafs as per claim 1 wherein:
a. The temperature is kept by a closed loop controlled heat pump at such a value that the freshness and nutritive properties of the Aloe Vera jell and/or juice are preserved.
b. A press for extracting the Aloe Vera jell and/or juice
c. A recipient for collecting the Aloe Vera jell and/or juice
d. A conveyor for disposing the waste remaining subsequent to the extraction of the jell and/or juice

3. A purifying subsystem as per claim 1 for cleansing the extracted Aloe Vera from impurities wherein:
a. A number of noble metal mesh filters of different granularity sizes are used to clean the Aloe Vera jell and/or juice from impurities.
b. An outlet for collecting part of the jell and/or juice serving for growing the bacteria and a second outlet for collecting a large part of the Aloe Vera Jell and/or juice to be mixed with grown bacteria or with dairy and bacteria in the final product and or products for topical use.
c. A cleansing turbine for flushing the purifying subsystem after use.

4. A set of bio chambers as per claim 1 in which bacteria are grown each chamber wherein:
a. A Recipient made of inert metal food grade having a sealable door
b. A number of small reservoirs in which Aloe Vera jell and/or juice and germs to be grown are added at the optimal growing ratio specific to the germ that is to be grown.
c. A clean air pump supplying the optimal temperature assuring the growth of the germs.
d. A temperature recorder for in process and after process monitoring
c. An alarm system for signaling an event in which the temperature went out of the desired limits.

5. A set of controlled speed centrifuges as per claim 1 for separating bacteria each centrifuge wherein:
a. A body made of inert metal food grade.
b. A servo closed loop control mechanism for managing the rotation speed of the centrifuge.
c. A number of recipients for collecting the resulting raw bacteria of different types.
d. A recipient for collecting grown bacteria separated from the Aloe Vera jell and/or juice that is or is not diluted with purified water used as a bacteria growth bed.
e. A recipient for collecting the residual growing bed material

6. A salts purification and milling bench as per claim 1 wherein
a. Salts are cleaned from impurities using H2O
b. The salts diluted in water is then filtered using micro mesh filters made of inert food grade metal,
c. Then the salts are dried using relatively low temperatures and vents
d. In the end the slats are micro milled to a micron size powder.

7. An array of subsystems for mixing the finite products as per claim 1 wherein
a. A number of refrigerators for storing the raw dairy components. Aloe Vera jell and/or juice and grown bacteria
b. A closed loop refrigerator temperature monitoring set as needed
c. A temperature recording device registering the temperature levels in each refrigerator
d. An alarm device alerting for any event in which the temperature in a refrigerator gels out of the allowed limits
c. A number of mixing chambers in which the materials stored in the refrigerators are combined according to a tailored formulae as requested by the client.
f. A packing system for packing the finite products in the desired recipients as defined by the customer.
g. An array of refrigerators having controlled and stabilized temperature for storing the finite products.
